(19) United States
(12) Patent Application Publication
(10) Pub. No.: US 2007/0252451 A1
(43) Pub. Date: Nov. 1, 2007

(54) Motor having heat-dissipating structure for circuit component and fan unit including the motor

(76) Inventors: Naotaka Shibuya, Kyoto (JP); Satoru Hanaoka, Kyoto (JP)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/785,812

(22) Filed: Apr. 20, 2007

(30) Foreign Application Priority Data
Apr. 28, 2006 (JP) 2006-127091

(51) Int. Cl. H02K 3/24; H02K 7/00; F04B 17/00; F04B 35/04

(52) U.S. Cl. 310/64; 310/67 R; 417/354; 417/423.8

(57) ABSTRACT

A motor includes a rotor and a stator. The stator includes a circuit board on which a control circuit for controlling rotation of the rotor is formed. A circuit component of the control circuit is mounted on a surface of the circuit board facing a base portion. A heat conductive member is arranged between the base portion and the circuit component to be in contact with the base portion and the circuit component. Thus, a heat generated by the circuit component is transferred to the base portion through the heat conductive member and is then transferred to connecting portions and a wall of a housing which are formed integrally with the base portion from thermally conductive material.

### BACKGROUND OF THE INVENTION

1. Field of the Invention

The present invention relates to a motor having a heat-dissipating structure for a circuit component mounted on a circuit board, and a fan unit including the motor.

2. Description of the Related Art

The amount of heat generated by circuit components, e.g., MPU, arranged in electronic devices has recently continued to increase with improvement of performances of the electronic devices. The generated heat raises the temperature inside a casing of the respective electronic device. Thus, cooling fan units are incorporated in the electronic devices, each of which cools the inside of the casing of the respective electronic device or a specific circuit component.

In conventional cooling fan units, an electric motor drives and rotates a plurality of blades for generating a current of air. The electric motor includes: a rotor arranged to be rotatable around a center axis and including an impeller and a rotor magnet; a stator opposed to the rotor magnet in a radial direction perpendicular to the rotation axis; and a base portion on which the stator is placed. The blades are attached to the rotor to be rotatable together with the rotor. The stator includes a stator core and a coil wound around the stator core. A part of the coil is electrically connected to a circuit component of a control circuit which controls rotation of the rotor. When a driving current is supplied to the control circuit from the outside of the electric motor and flows through the coil, a magnetic field is generated around the stator core. The thus generated magnetic field interacts with a magnetic field generated by the rotor magnet, thereby generating rotating torque acting on the rotor.

Demands for cooling fan units having higher cooling performances than the conventional cooling fan units have increased in order to further cool the inside of electronic devices. In general, in order to improve a cooling performance of a cooling fan unit, it is necessary to increase a flow rate of the cooling fan unit so as to increase the amount of air discharged from the inside of a casing of an electronic device to the outside. In order to increase the flow rate of the fan unit, a flow rate of a current of air created by rotation of the impeller in the fan unit has to be increased. When the flow rate of the current of air is increased, the amount of work of the impeller is increased, resulting in increase in a current supplied to the cooling fan unit.

When a current flows through a circuit component mounted on a circuit board, a temperature of the circuit component raises because of internal electric resistance of the circuit component. The larger the current is, the larger the temperature rise is. Every circuit component of a circuit controlling rotation of the impeller has its own allowable temperature rise which is predetermined. Thus, if the temperature rise of a circuit component exceeds its allowable temperature rise, for example, a trouble with the circuit component, e.g., malfunction, may occur. For this reason, a motor should be designed in such a manner that an internal temperature of every circuit component is suppressed not to exceed its allowable temperature rise. Especially in a cooling fan unit in which a large current flows through a circuit component, a part or member that can forcedly dissipate heat generated by the circuit component on the circuit board in order to achieve high safety and reliability.

Japanese Unexamined Patent Publication No. 2006-70836 discloses a fan unit which includes a structure for dissipating heat generated by a heat-generating component on a circuit board. A portion of a housing of the fan unit, which retains a stator to be opposed thereto, has recesses each corresponding to an appearance of a heat-generating component on the circuit board. In the recess, a member for aiding heat transfer is arranged. Thus, the heat transfer aiding member is arranged between the stator retaining portion and the heat-generating component on the circuit board.

### SUMMARY OF THE INVENTION

According to preferred embodiments of the present invention, a motor having the following structure is provided. A stator includes a stator core, teeth radially extending from the stator core, and a coil wound around each tooth. A rotor is rotatable about a rotation axis relative to the stator. A base portion is made of thermally conductive member and is arranged axially below the stator. A circuit board is arranged axially between the stator and the base portion and is secured to one of the stator and the base portion. The circuit board has a circuit component which is mounted thereon and forms a control circuit for controlling rotation of the rotor. A heat conductive member is made of thermally conductive material and is arranged axially between the circuit component mounted on the circuit board and the base portion. In this motor, the heat conductive member is sandwiched between the circuit component on the circuit board and the base portion to be in contact with at least a part of the circuit component and the base portion, and one of the heat conductive member and the circuit board is elastically deformed.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a cross-sectional view of a fan unit according to a first preferred embodiment of the present invention, taken along a plane including a center axis of the fan unit.

FIG. 2 is an enlarged cross-sectional view of a main part of the fan unit of FIG. 1, including a bearing.

FIG. 3 is an exploded view of the fan unit of FIG. 1.

FIG. 4 is a cross-sectional view of a modified example of the fan unit of the first preferred embodiment of the present invention.

FIG. 5 is a cross-sectional view of another modified example of the fan unit of the first preferred embodiment of the present invention.

FIG. 6 is a cross-sectional view of still another modified example of the fan unit of the first preferred embodiment of the present invention.

FIG. 7 is a cross-sectional view of a fan unit according to a second preferred embodiment of the present invention.

FIG. 8 is an exploded view of the fan unit of FIG. 7.

### DETAILED DESCRIPTION OF PREFERRED EMBODIMENTS

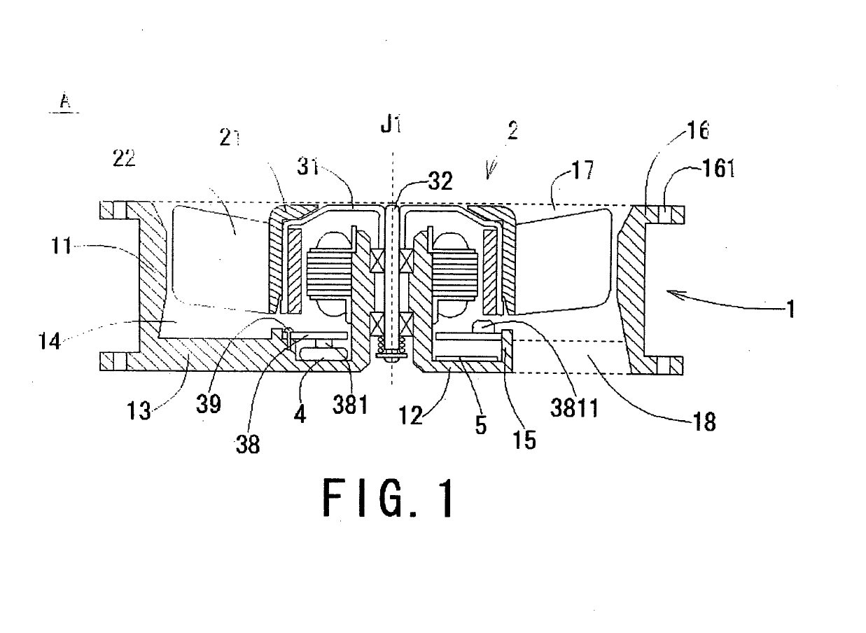

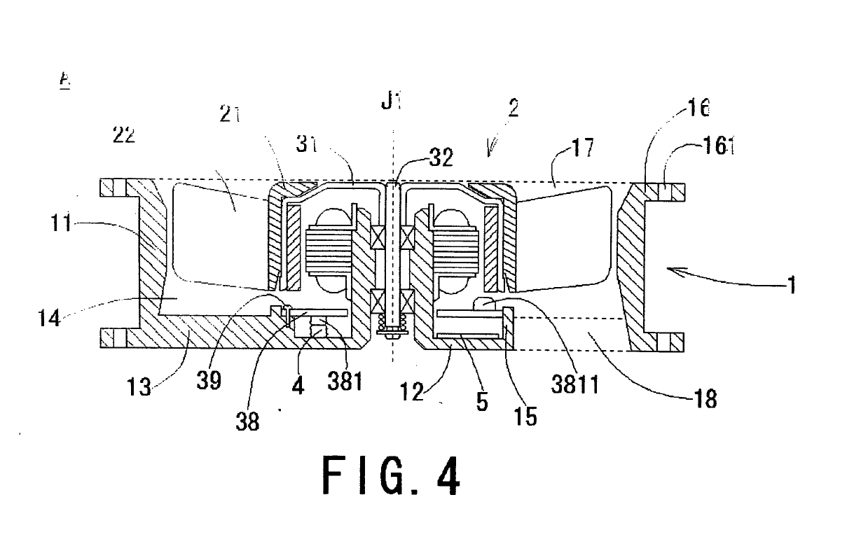

Referring to FIGS. 1 through 8, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### First Preferred Embodiment

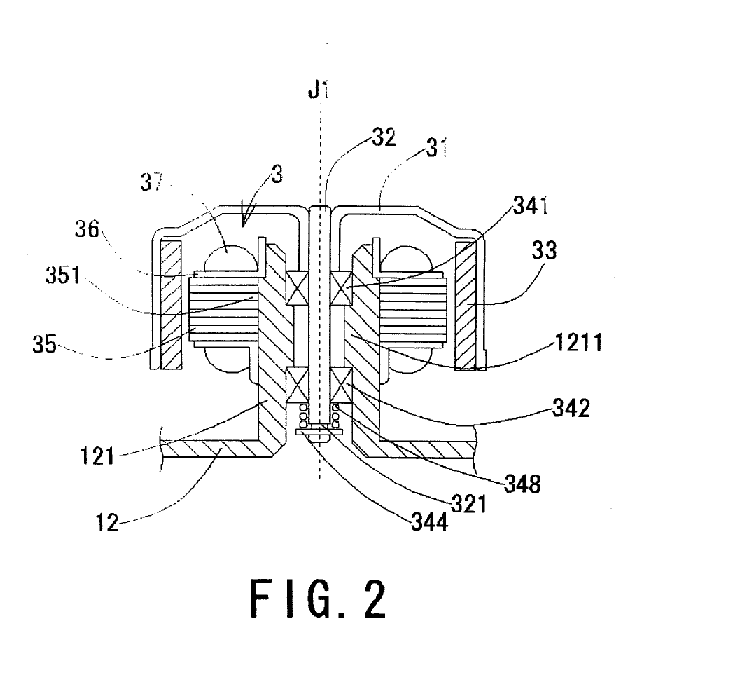

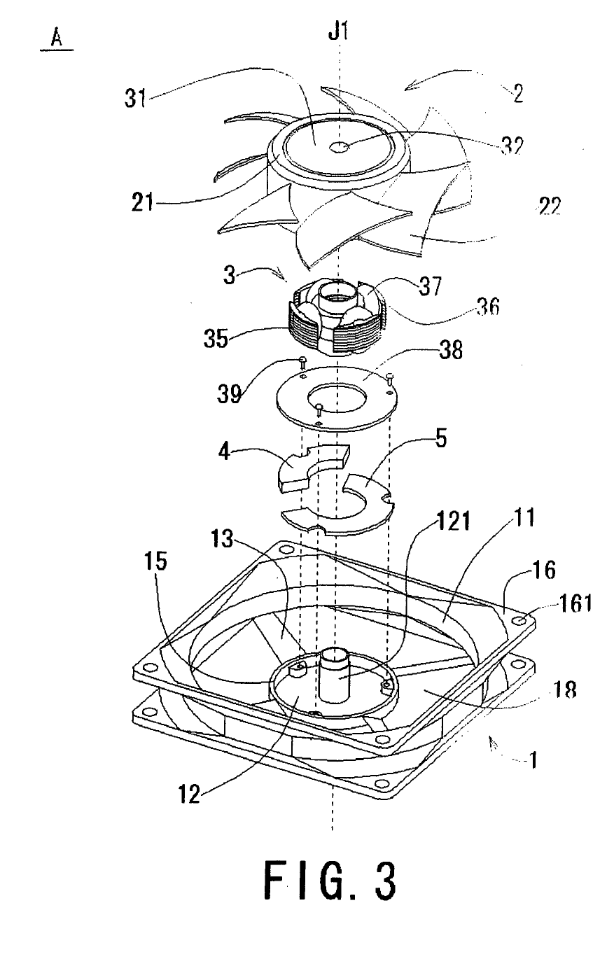

FIG. 1 shows a fan unit A according to a first preferred embodiment of the present invention. FIG. 2 is an enlarged cross-sectional view of a main part of the fan unit A of FIG. 1, including a bearing. FIG. 3 is a perspective view of the fan unit A of FIG. 1.

When a current is supplied to the fan unit A from the outside, an impeller 2 having a plurality of blades 22 is rotated. The impeller 2 includes a hollow, substantially cylindrical impeller cup 21. The blades 22 are arranged on an outer circumferential surface of the impeller cup 21 to extend radially outwardly.

A hollow, substantially cylindrical rotor yoke 31 having a substantially closed end is arranged inside the impeller cup 21. The rotor yoke 31 is inserted into the impeller cup 21 by interference fitting and is in contact with an inner circumferential surface of the impeller cup 21. The rotor yoke 31 receives a rotor magnet 33 therein. The rotor magnet 33 is inserted to the inside of the rotor yoke 31 by interference fitting to be in contact with an inner circumferential surface of the rotor yoke 31. The rotor yoke 31 is usually formed by pressing considering mass productivity.

The rotor magnet 33 is magnetized to achieve multiple poles alternately arranged in its circumferential direction. Magnetization of the rotor magnet 33 is usually carried out after interference fitting. However, magnetization can be carried out for the rotor magnet 33 alone. That is, magnetization of the rotor magnet 33 may be carried out before interference fitting of the rotor magnet 33 into the rotor yoke 31. The rotor yoke 31 is made of anti-corrosive magnetic material, such as stainless. Thus, the rotor yoke 31 can form a magnetic circuit together with the rotor magnet 33, thereby reducing leakage of magnetic fluxes from the rotor magnet 33 to the outside of the impeller 2 and increasing a density of the magnetic fluxes generated by the rotor magnet 33

The rotor yoke 31 is provided at its center with a shaft insertion hole to which a shaft 32 is inserted and secured. The shaft insertion hole is formed when the rotor yoke 31 is formed by pressing. Referring to FIG. 2, the shaft 32 is supported by an upper ball bearing 341 and a lower ball bearing 342 in a rotatable manner around a center axis J1. The upper ball bearing 341 is arranged axially away from the lower ball bearing 342. A base portion 12, arranged to face an opening end of the impeller cup 21 and that of the rotor yoke 31, includes a bearing housing 121 at its center. The bearing housing 121 is hollow and substantially cylindrical and has a raised-up portion 1211 on its inner circumferential surface. The raised-up portion 1211 is raised up radially inwardly.

The upper ball bearing 341 is inserted into the bearing housing 121 from above in the axial direction and is placed on an axially upper surface of the raised-up portion 1211. The lower ball bearing 342 is inserted into the bearing housing 121 from below in the axial direction and is arranged to be in contact with an axially lower surface of the raised-up portion 1211. A midpoint between the upper and lower ball bearings 341 and 342 in the axial direction is arranged to be as close as possible to a center of gravity of a rotating object. A spring 348 applies a pressure to the lower ball bearing 342 from below in the axial direction. The spring 348 is sandwiched and secured between the lower ball bearing 342 and a wire ring 344 which is secured in an annular groove 321 formed at a portion of the shaft 32 near an axially lower end of the shaft 32.

Returning to FIG. 1, a housing 1 surrounds the impeller 2 from outside in the radial direction and has openings at both axial ends. One of the two openings serves as an air inlet 17 and the other serves as an air outlet 18. A current of air created by rotation of the impeller 2 flows from the air inlet 17 toward the air outlet 18. In this preferred embodiment, each of axially upper and lower surfaces of the housing 1 is square when seen in the axial direction, as shown in FIG. 3. However, the shape of the upper and lower surfaces of the housing 1 is not limited thereto. For example, the upper and lower surfaces of the housing 1 may be circular. In this preferred embodiment, a flange 16 is formed at each of four corners of the upper and lower surfaces of the housing 1, as shown in FIG. 3. Each flange 16 extends radially outwardly and is provided with a hole 161 extending through the flange 16. An attaching tool such as a screw 39 is inserted into each hole 161, thereby attaching the fan unit A to an electronic device.

The base portion 12 is arranged at a center of the lower surface of the housing 1. Four connecting portions 13 extend from an outer periphery of the base portion 12 radially outwardly and are connected to an inner side face of the housing 1. In this manner, the base portion 12 is secured to the housing 1 with the connecting portion 13. The number of the connecting portions 13 is not limited to four, but may be three or less or five or more.

The connecting portions 13 cross a passage 14 for a current of air defined by a wall 11 of the housing 1. Thus, the current of air created by rotation of the impeller 2 interfere with the connecting portions 13. A cross section of each connecting portion 13 cut along a plane perpendicular to a longitudinal direction of the connecting portion 13 is usually designed to be approximately triangular in order to reduce air resistance and enhance the strength of the connecting portion 13. However, the cross-sectional shape of the connecting portion 13 is not limited thereto. For example, the shape of the connecting portion 13 in the cross section perpendicular to its longitudinal direction may be blade-like shaped.

In this preferred embodiment, the base portion 12 is arranged on an air outlet side of the housing 1, i.e., in the lower surface of the housing 1. However, the base portion 12 connected with the connecting portions 13 to the housing 1 may be arranged on an air inlet side, i.e., in the upper surface of the housing 1.

The base portion 12 is provided with a substantially annular wall portion 15 standing axially on an outer perimeter of the base portion 12. The base portion 12 is connected to the respective connecting portions 13 via the wall portion 15. With this configuration, the radially inner end face of each connecting portion 13 can be entirely connected to the base portion 12 and/or the wall portion 15, so that the strength of securing the base portion 12 to the connecting portions 13 can be enhanced. Moreover, since the wall portion 15 is formed on the outer perimeter of the base portion 12, a cross section of the base portion 12 including the wall portion 15, taken along a plane containing the axial direction, has a square U-shape. Thus, moment of inertia of the cross section of the base portion 12 increases, enhancing the strength of the base portion 12.

In this preferred embodiment, the housing 1 is made of aluminum alloy having a thermal conductivity of 96 W/(m*K) and is formed by casting. The housing 1, the base portion 12 including the bearing housing 121, and the connecting portions 13 are integrally formed each other. In casting, aluminum alloy is forced into a die and is cooled inside the die. After taken out of the die, the aluminum alloy casting is cooled by natural cooling. The housing 1 formed by the aluminum alloy casting has high strength and high heat-resistance and therefore can be used in severe environments, for example, in which a high load is applied to the housing 1 or a surrounding temperature is high. Casting is high in productivity because a number of castings can be obtained by using a single die. In addition, casting can easily form the housing 1 having a complicated shape with high dimensional accuracy. If a bearing has to have high reliability, a portion of the aluminum alloy casting, serving as the bearing housing 121, may be subjected to an additional process, e.g., cutting, thereby improving coaxiality and circularity of the bearing housing 121.

The material for the housing 1 is not limited to aluminum alloy. Examples of the material for the housing 1 are zinc alloy and magnesium alloy. Any metal having a good thermal conductivity can be used as the material for the housing 1. Moreover, the housing 1 may be formed by pressing a metal plate such as a steel plate.

The stator 3 is secured to an outer circumferential surface of the bearing housing 121, and includes a stator core 35, a coil 37, and an insulator 36. The stator core 35 is arranged to be radially opposed to the rotor magnet 33 secured on the inner circumferential surface of the rotor yoke 31, as shown in FIG. 2. The stator core 35 and the rotor magnet 33 face each other with a gap interposed therebetween. The coil 37 is wound around each tooth 351 arranged at a radially outer end of the stator core 35 via the insulator 36 made of insulating material, as shown in FIG. 3. A circuit board 38 on which a control circuit for controlling rotation of the impeller 2 is formed is arranged axially below the stator core 35.

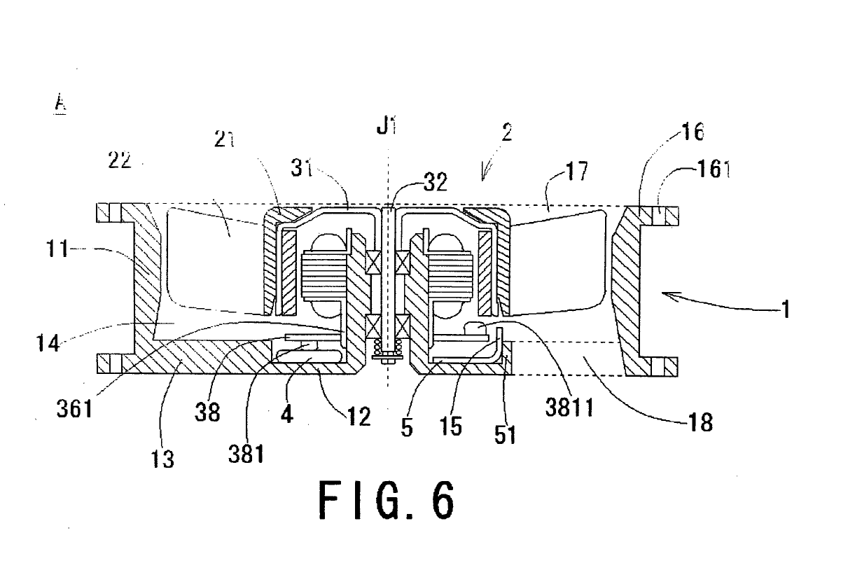

One surface of the circuit board 35 has a circuit pattern formed thereon. In this preferred embodiment, the circuit board 35 is formed by a phenolic-resin paper substrate and copper foil is formed as the circuit pattern. The circuit board 38 is arranged in such a manner that the surface having the circuit pattern faces the base portion 12. That is, the surface of the circuit board 38 with the circuit pattern is axially opposed to an upper surface of the base portion 12. The circuit board 38 is secured to projections which are provided at an axially upper end of the wall portion 15 and extend radially inwardly with screws 39, respectively, as shown in FIG. 3. Alternatively, as shown in FIG. 6, the circuit board 38 may be secured to a radially outer surface of an extension 361 of the insulator 36 of the stator 3 which extends downward in the axial direction. Instead, the circuit board 38 may be secured to the base portion 12. How to secure the circuit board 38 is not specifically limited as long as it is secured to one of the stator 3 and the base portion 12.

A land on which a circuit component 381 is to be mounted is formed on the circuit pattern on the circuit board 38. The circuit component 381 mounted on the land is electrically connected to an end of the coil 37 of the stator 3, thereby forming a circuit. When a current supplied to the circuit pattern from an external power supply via a lead wire (not shown) is supplied to the coil 37 via the circuit component 381 such as a driving IC and a Hall Effect device 3811, a magnetic field is generated around the stator core 35. The thus generated magnetic field interacts with a magnetic field generated by the rotor magnet 33, thereby generating rotating torque acting on the impeller 2. Thus, the impeller 2 is rotated.

The Hall Effect device 3811 mounted on the circuit board 38 is used for detecting a rotational position of the impeller 2. When the impeller 2 is rotated, magnetic fluxes from the rotor magnet 33 are detected by the Hall Effect device 3811. Since the rotor magnet 33 are magnetized to have multiple poles alternately arranged in its circumferential direction, the magnetic fluxes passing axially above the hall effect device 3811 are varied with rotation of the impeller 2. Thus, the Hall Effect device 3811 can detect the rotational position of the impeller 2. The Hall Effect device 3811 may be replaced with a hall IC including an amplifier circuit therein. In this preferred embodiment, a magnetic sensor, i.e., the Hall Effect device 3811 which detects magnetic fluxes is used for detecting the rotational position of the impeller 2. However, instead of using the magnetic sensor, another detecting device may be used.

In addition to the Hall Effect device 3811, a driving IC is mounted on the circuit board 38. The driving IC is an exemplary circuit component 381 forming a control circuit for controlling rotation of the impeller 2 and can switch an output voltage supplied to the coil 37. Due to the presence of the Hall Effect device 3811 and the driving IC, a rotation speed of the impeller 2 can be controlled.

When an electric current flows through the circuit component 3811, the circuit component 3811 generates heat due to its electric resistance. As a flow rate of a current of air created by rotation of the impeller 2 is increased, the amount of work of the impeller 2 also increases. Thus, an electric current flowing through the circuit component 381 becomes larger, resulting in increase in the amount of heat generated by the circuit board 381.

A heat conductive member 4 made of thermally conductive material is arranged between the circuit component 381 and the base portion 12, as shown in FIG. 1. The heat conductive member 4 is arranged to be in contact with at least a part of the circuit component 381 and the base portion 12. The circuit board 38 may be elastically deformed by the contact between the circuit component 381 and the heat conductive member 4. In this case, a direction of elastic deformation of the circuit board 38 is such a direction that a portion near a connected portion of the circuit board 38 to the stator 3 or the base portion 12 becomes closer to the heat conductive member 4.

With this configuration, the heat generated by the circuit component 381 is transferred to the base portion 12 via the heat conductive member 4. This heat is then transferred to the connecting portions 13 and then other portions of the housing 1, because the housing 1 including the wall portion 11, the base portion 12, and the connecting portions 13 is integrally formed as one component from thermally conductive material, e.g., aluminum alloy. The heat transferred to the base portion 12, the connecting portions 13, and other portions of the housing 1 is forcedly dissipated to the outside by a current of air created by rotation of the impeller 2 and flowing in the axial direction. The heat conductive member 4 is accommodated in a substantially closed space defined by the wall portion 15, the circuit board 38, and the base portion 12. It is preferable that the thermal conductivity of the heat conductive member 4 be as high as possible.

In this preferred embodiment, the heat conductive member 4 is made of elastically deformable member. The use of the elastically deformable member has the following advantages. When the circuit component 381 is mounted on one surface of the circuit board 38, a base portion side of the circuit component 381 becomes irregular. If the heat conductive member 4 is made of elastically deformable member, the member 4 can change a shape of its surface to be in contact with the circuit component 381 in accordance with the irregularity of the base portion side of the circuit board 38, when arranged between the base portion 12 and the circuit board 381. More specifically, the surface of the heat conductive member 4, which is in contact with the circuit component 381, is deformed in such a direction that the heat conductive member 4 becomes thin. Thus, an area of contact between the circuit board 381 and the heat conductive member 4 increases and therefore efficiency of heat transfer from the circuit component 381 to the heat conductive member 4 is increased.

Moreover, the circuit board 38 on which a plurality of circuit components 381 which are not the same in an axial height are mounted is considered. Distances of the upper surface of the base portion 12 from respective lower surfaces of circuit components 381 are not the same. If the heat conductive member 4 formed by elastically deformable material is arranged between the base portion 12 and the respective circuit components 381, the heat conductive member 4 changes a shape thereof in accordance with the shapes of the circuit components 381. Thus, an area of contact between the heat conductive member 4 and each circuit component 38 increases. Accordingly, the heat generated by each circuit component 381 can be transferred to the base portion 12 more efficiently.

In addition, the heat conductive member 4 elastically deformable can flexibly respond to a change of a mounting position of the circuit component 381 on the circuit board 38 and a change of the circuit component 381 itself caused by a change in the specification of the impeller 2, e.g., a change of a rotation control method or rotation speed. Moreover, the shape of the heat conductive member 4 can be easily deformed in accordance with a specific circuit component 381 which especially requires heat dissipation.

Furthermore, the heat conductive member 4 made of elastically deformable material and arranged between the circuit board 38 and the base portion 12 can absorb vibration caused by rotation of the impeller 2 and transferred to the circuit board 38, due to its elasticity. Thus, both a noise value and a vibration value of the fan unit A can be reduced.

For example, a thermally conductive silicone rubber sheet with low hardness, e.g., TC-TXS, available from Shin-etsu Chemical Co., Ltd. can be used as the heat conductive member 4. The silicone rubber sheet is soft and has excellent adhesiveness. Thus, adhesion of the silicone rubber sheet to the circuit component 381 can be improved.

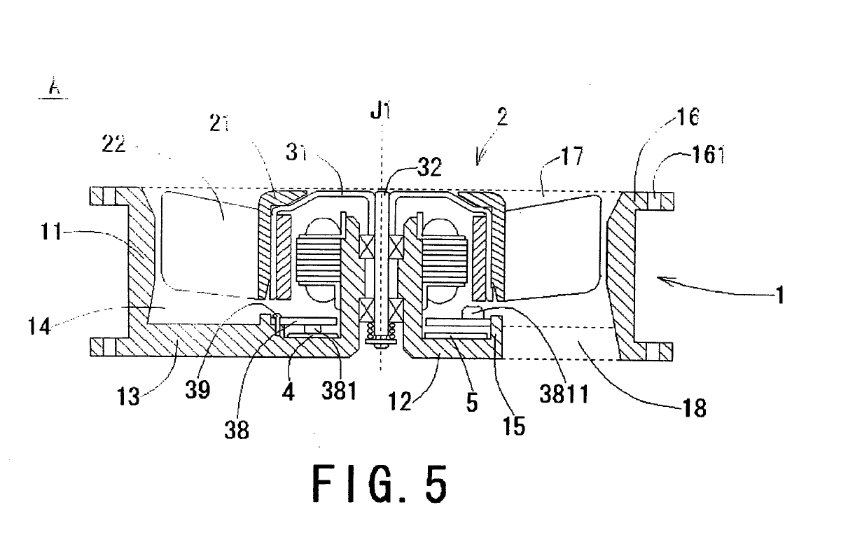

FIG. 5 shows an exemplary modification of the fan unit A of this preferred embodiment. In this modification, the thickness of the base portion 12 is increased axially upward to make the upper surface of the base portion 12 closer to the lower surface of the circuit board 38. That is, a distance between the base portion 12 and the circuit component 381 is reduced. When the distance between the base portion 12 and the circuit board 381 is reduced, the heat conductive member 4 can be made thinner. The reduction in thickness of the heat conductive member 4 in turn reduces the used amount of the material for the heat conductive member 4 and heat resistance of the heat conductive member 4. Thus, the heat generated by the circuit component 381 can be transferred to the base portion 12 more easily.

In the example of FIG. 5, the thickness of the base portion 12 is increased axially upward by about 2 mm, as compared with the thickness of the base portion 12 in the example of FIG. 1. This means that the thickness of the heat conductive member 4 arranged between the base portion 12 and the circuit component 381 is thinner in the example of FIG. 5 than in the example of FIG. 1 by about 2 mm. For both the examples of FIGS. 1 and 5, a surface temperature of the circuit component 381 was measured as an indicator of the amount of the heat generated by the circuit component 381. The surface temperature of the circuit component 381 was lower in the example of FIG. 5 than in the example of FIG. 1 by about 8 degree Celsius. Therefore, reduction of about 2 mm in the thickness of the heat conductive member 4 can lower the surface temperature of the circuit component 381 by about 8 degree Celsius. In the measurement carried out for the structures shown in FIGS. 1 and 5, the thickness of the base portion 12 was set to about 3.5 mm and about 5.5 mm, and the distance between the base portion 12 and the circuit component 381 was set to about 3.5 mm and about 1.5 mm, respectively. Please note that a single circuit component 381 was mounted on the circuit board 38.

Instead of increasing the thickness of the base portion 12, a projection may be formed on the upper surface of the base portion 12 at a position where the heat conductive member 4 is to be arranged in such a manner that the projection projects toward the circuit board 38. In this case, the heat conductive member 4 is arranged between the projection and the circuit component 381. The same effects as those obtained when the thickness of the base portion 12 is increased can be also achieved in this case.

The material for the heat conductive member 4 is not specifically limited, as long as it has a high thermal conductivity and at least one of the heat conductive member 4 and the circuit board 38 is elastically deformable. For example, the heat conductive member 4 may be formed by a heat conductive sheet which is formed by applying pressure-sensitive adhesive including a reinforcing agent on a base member such as aluminum foil. Alternatively, thermally conductive silicone resin in the form of grease, in which powders having a high thermal conductivity such as alumina are blended with base oil such as silicone oil, may be used as the heat conductive member 4. In this preferred embodiment, at least one of the circuit board 38 and the heat conductive member 4 is elastically deformed so as to increase the area of contact between the circuit component 381 and the heat conductive member 4 and improve adhesion therebetween.

As described above, the base portion 12 is made of material having good thermal conductivity, e.g., aluminum alloy. It is preferable that the thermal conductivity of the base portion 12 be larger than that of the heat conductive member 4 in this preferred embodiment.

When the material for the base portion 12 is electrically conductive, it is necessary to electrically insulate the circuit board 38 and the base portion 12 from each other. In this preferred embodiment, in a region where the heat conductive member 4 is arranged between the circuit board 38 and the base portion 12, the circuit board 38 and the base portion 12 are electrically insulated from each other because the silicone rubber sheet serving as the heat conductive member 4 is electrically insulating. On the other hand, in a region where no heat conductive member 4 is arranged between the circuit board 38 and the base portion 12, an insulating sheet 5, e.g., a polyester film is arranged between the circuit board 38 and the base portion 12. That is, the circuit board 38 and the base portion 12 are electrically insulated from each other by one of the insulating sheet 5 and the heat conductive member 4 in this preferred embodiment. Thus, the circuit board 38 can be electrically insulated from other components in the fan unit A and from the outside of the fan unit A more reliably. Accordingly, even when a high voltage is applied to a casing of the fan unit A, i.e., the housing 1, by lightning, short-circuit between the circuit board 38 and the base portion 12 can be prevented.

Although the circuit board 38 is electrically insulated from the base portion 12 by one of the heat conductive member 4 and the insulating sheet 5, electrical insulation may be achieved by both of the member 4 and the insulating sheet 5. That is, the heat conductive member 4 and the insulating sheet 5 may be overlapped by each other in the axial direction.

FIG. 6 shows another modification of the fan unit A of the first preferred embodiment of the present invention. In this modification, an outer peripheral portion of the insulating sheet 5 is bent upward in the axial direction so as to form a bent portion 51. The bent portion 51 forms a part of the wall portion 15. A distance between the impeller cup 21 and the bent portion 51 can be made narrower by extending an axially upper end of the bent portion 51 axially upward. In this case, it is possible to prevent a foreign particle from entering a space defined by the bent portion 51, the impeller 2, and the base portion 12.

### Second Preferred Embodiment

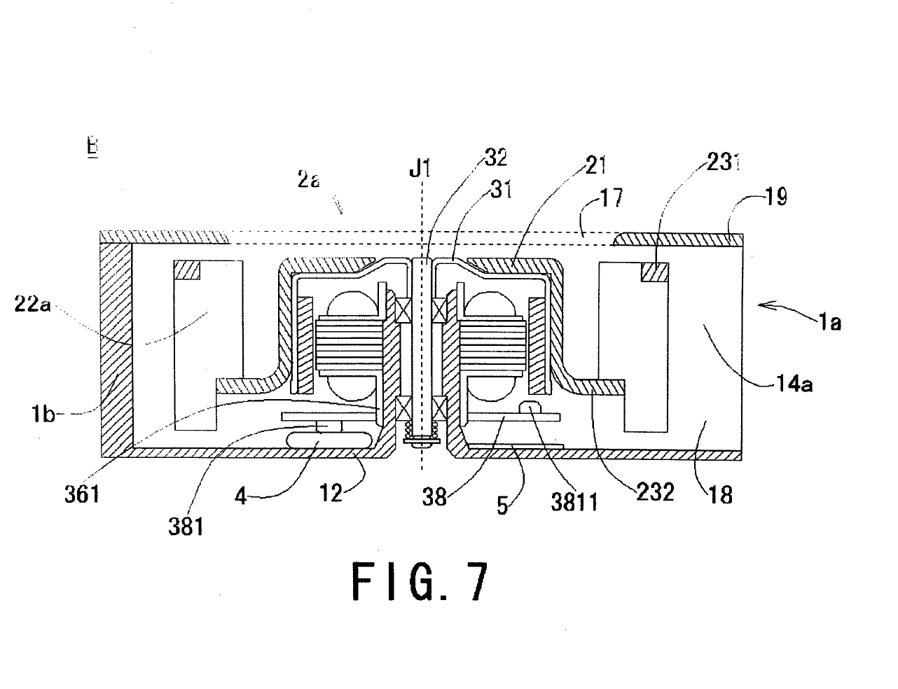

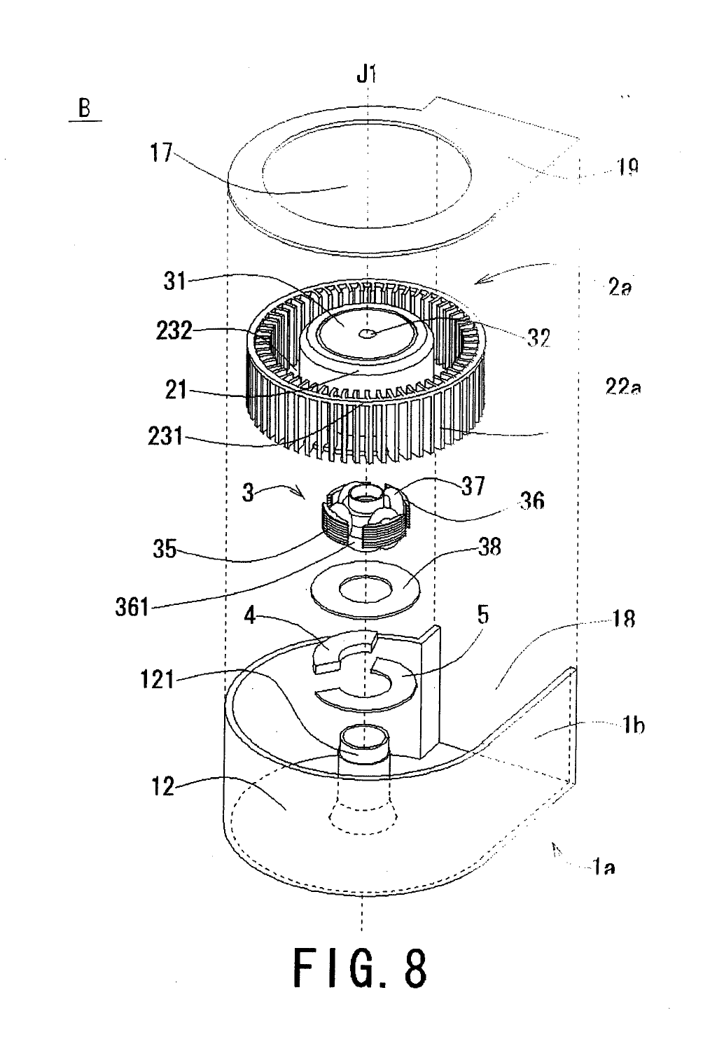

FIG. 7 is a cross-sectional view of a fan unit B according to a second preferred embodiment of the present invention. FIG. 8 is a perspective view of the fan unit B of FIG. 7.

The fan unit B is different from the fan unit A of the first preferred embodiment in the structure of the impeller and housing. Except for that, the fan unit B is similar to the fan unit A. So, like components are labeled with like reference numerals and detailed description thereof is omitted.

An impeller 2a includes a hollow, substantially cylindrical impeller cup 21, as shown in FIGS. 7 and 8. A plurality of blades 22a are annularly arranged radially outside the impeller cup 21 with their center placed on the center axis J1 of rotation of the fan unit B. The blades 22a are connected to each other with an upper blade connecting portion 231 and a lower blade connecting portion 232. The lower blade connecting portion 232 radially extends from an outer circumferential surface of the impeller cup 21. The shape of the impeller 2a is not limited to the above. For example, a plurality of blades 22a may be formed on the outer circumferential surface of the impeller cup 21. The impeller 2a can have any shape as long as rotation of the impeller 2a creates a current of air in which an air is taken in the axial direction and is discharged radially outwardly.

The base portion 12 is arranged at an axially lower end of the fan unit B, as shown in FIGS. 7 and 8. A housing side wall 1b is formed on an outer perimeter of the base portion 12 to surround the impeller 2a from outside in the radial direction. The base portion 12 and the housing side wall 1b are integrally formed with each other, thereby forming a housing 1a. A housing cover 19 having an air inlet 17 formed therein is attached at an axially upper end of the housing side wall 1b, as shown in FIGS. 7 and 8. A passage 14a for a current of air created by rotation of the impeller 2a is defined by the base portion 12, an inner surface of the housing side wall 1b, the housing cover 19, and an envelope surface formed by outer rims of the blades 22. An air flowing through the passage 14a is discharged to the outside of the fan unit B via an air outlet 18 formed in the housing side wall 1b. The air inlet 17 may be formed in the base portion 12, instead of in the housing cover 19. That is, the air inlet 17 is formed in one of the housing cover 19 and the base portion 12.

The width of the passage 14a in a cross section perpendicular to the center axis J1 gradually increases toward the air outlet 18. However, the design of the passage 14a is not limited thereto. For example, in a compact fan of which a cross section perpendicular to the central axis J1 has sides of 20 mm or less, the width of the passage 14a in that cross section may be constant. This is because there is almost no loss of flow rate if the width of the passage 14a in that cross section is made constant.

The circuit board 38 is provided with a circuit pattern formed on its one surface and is arranged with that surface facing the base portion 12, i.e., with the circuit pattern facing down in a similar manner to that in the first preferred embodiment. The circuit board 38 is secured to a radially outer surface of the extension 361 of the insulator 36 of the stator 3. The extension 361 of the insulator 36 extends axially downward.

A circuit component 381 is mounted on the circuit pattern of the circuit board 38, that is, on the surface facing the base portion 12. The heat conductive member 4 made of thermally conductive material is arranged between the circuit component 381 on the circuit board 38 and the base portion 12, as shown in FIG. 7. It is preferable that the thermal conductivity of the heat conductive member 4 be as high as possible. The material for the heat conductive member 4 is selected considering the thermal conductivity, adhesiveness, and the like. Heat generated by the circuit component 381 is transferred to the base portion 12 through the heat conductive member 4. Then, the thus transferred heat is at least partially transferred to another portion of the housing 1a and is diffused in the housing 1a, because the base portion 12 is formed integrally with the other portion of the housing 1a to form the housing 1a. The heat transferred to the base portion 12 and the housing 1a is forcedly dissipated to the outside by a current of air created in the axial and radial directions by rotation of the impeller 2a.

In this preferred embodiment, the heat conductive member 4 is made of material which has thermal conductivity and can be elastically deformed, i.e., a silicone rubber sheet. Thus, the same effects described in the first preferred embodiment can be also achieved in this preferred embodiment.

Moreover, it is enough that at least one of the circuit board 38 and the heat conductive member 4 is elastically deformable. That is, when the heat conductive member 4 is not deformed or is hard to deform, the circuit board 38 is formed to be elastically deformable. This increases the area of contact between the circuit component 381 and the heat conductive member 4 and improves the adhesion therebetween, thereby improving the efficiency of heat transfer from the circuit component 381 to the base portion 12 via the heat conductive member 4.

### Other Embodiments

The fan units are described in the above first and second preferred embodiments. However, the present invention is not limited thereto. The present invention can be applied to other DC brushless motors as long as heat generated by the circuit component 38 is transferred to the base portion 12 through the heat conductive member 4.

In the first and second preferred embodiments, the DC brushless motors in the fan units B are outer rotor type motors in which the rotor magnet 33 is arranged radially outside the teeth 351 of the stator 3 to face the teeth 351 with a gap interposed therebetween. However, the present invention can also be applied to inner rotor type motors in which the rotor magnet 33 facing the teeth 351 is arranged radially inside the teeth 351 with a gap interposed therebetween.

As described above, according to the preferred embodiments of the present invention, the heat conductive member is arranged axially between the circuit component on the circuit board and the base portion and is in contact with at least a part of the circuit component and the base portion. Thus, heat generated by the circuit component is transferred into the base portion which is a part of the housing of the fan unit, is diffused in another part of the housing, and is finally dissipated because the housing is made of material having a good thermally conductivity. Accordingly, a large current can flow through the circuit component on the circuit board. The heat conductive member is made of thermally conductive material.

Moreover, one of the heat conductive member and the circuit board connected to one of the stator and the base portion can be elastically deformed. Thus, adhesion between the heat conductive member and the circuit component on the circuit board is improved, so that efficiency of the heat transfer from the circuit component is improved.

According to the preferred embodiments of the present invention, the wall portion is formed on the outer perimeter of the base portion. It is therefore possible to accommodate the heat conductive member in a space defined by the wall portion. Moreover, the wall portion contributes to increase in a surface area of the member surrounding the heat conductive member. Thus, the efficiency of dissipating the heat generated by the circuit component can be improved.

When the base portion is formed by die-casting as in the preferred embodiments, the number of base portions manufactured in a certain time period can be increased, as compared with a case where the base portion is formed by cutting. Moreover, die-casting allows a number of base portions to be manufactured from a single mold. Thus, it is possible to improve the productivity.

In the fan unit according to the preferred embodiments, a current of air created by rotation of the impeller is made to hit the base portion made of heat conductive material and the member thermally connected to the base portion. Thus, the heat generated by the circuit component on the circuit board can be forcedly dissipated.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor comprising:
a stator including a stator core, a plurality of teeth radially extending from the stator core, and a coil wound around each tooth;
a rotor rotatable around a rotation axis relative to the stator;
a base portion made of thermally conductive member and arranged axially below the stator;
a circuit board arranged axially between the stator and the base portion, secured to one of the stator and the base portion, and having a circuit component which is mounted thereon and forms a control circuit for controlling rotation of the rotor; and
a heat conductive member which is made of thermally conductive material and is arranged axially between the circuit component mounted on the circuit board and the base portion to be in contact with at least a part of the circuit component and the base portion, wherein
at least one of the heat conductive member and the circuit board is elastically deformed.

2. The motor as set forth in claim 1, wherein the heat conductive member is made of elastic material.

3. The motor as set forth in claim 1, wherein the heat conductive member is formed by a silicone rubber sheet.

4. The motor as set forth in claim 1, wherein the heat conductive member is formed by thermal tape.

5. The motor as set forth in claim 1, wherein a thermal conductivity of the base portion is larger than that of the heat conductive member.

6. The motor as set forth in claim 1, wherein the base portion is formed by casting.

7. The motor as set forth in claim 1, wherein the base portion is made of aluminum alloy.

8. The motor as set forth in claim 1, wherein the heat conductive member electrically insulates the circuit board from the base portion.

9. The motor as set forth in claim 1, further comprising an insulating film arranged axially between the circuit board and the base portion and electrically insulating the circuit board from the base portion.

10. A fan unit comprising a plurality of blades creating a current of air when rotated, and the motor as set forth in claim 1 for driving the blades to rotate around the rotation axis.

11. The fan unit as set forth in claim 10, wherein the blades are attached on an outer circumference of the rotor to extend radially outwardly and create the current of air in which an air is taken in and discharged in an axial direction parallel to the rotation axis.

12. The fan unit as set forth in claim 11, wherein the blades are annularly arranged radially outside the rotor with their center placed on the rotation axis, and create the current of air in which an air is taken in an axial direction parallel to the rotation axis (J1) and is discharged radially outwardly.

13. The fan unit as set forth in claim 10, further comprising a housing for defining a passage for the current of air.

14. The fan unit as set forth in claim 13, wherein the housing includes the base portion, a wall portion, and connecting portions connecting the base portion to the wall portion and is formed integrally.
